(19) United States
(12) Patent Application Publication
(10) Pub. No.: US 2002/0168543 A1
(43) Pub. Date: Nov. 14, 2002

(54) ORGANIC ELECTROLUMINSCENT DEVICE

(76) Inventors: HITOSHI ISHIKAWA, TOKYO (JP); SATORU TOGUCHI, TOKYO (JP); YUKIKO MORIOKA, TOKYO (JP); ATSUSHI ODA, TOKYO (JP)

Correspondence Address: SUGHRUE MION ZINN MACPEAK & SEAS, 2100 PENNSYLVANIA AVENUE NW, WASHINGTON, DC, 200373202

(21) Appl. No.: 09/422,560

(22) Filed: Oct. 21, 1999

(30) Foreign Application Priority Data
Oct. 22, 1998 (JP) 301156/1998
Oct. 23, 1998 (JP) 302548/1998

(51) Int. Cl. H05B 33/14

(52) U.S. Cl. 428/690; 428/917; 313/504; 313/506

(57) ABSTRACT

An object of the present invention is to provide a blue-light emitting organic EL device having excellent color purity and high brightness. The present invention features that used as a component material of the organic EL device is a specific diphenylaminoarylene compound represented by any one of the following formulas [1], [3], [6], [7], [8] and [9]:

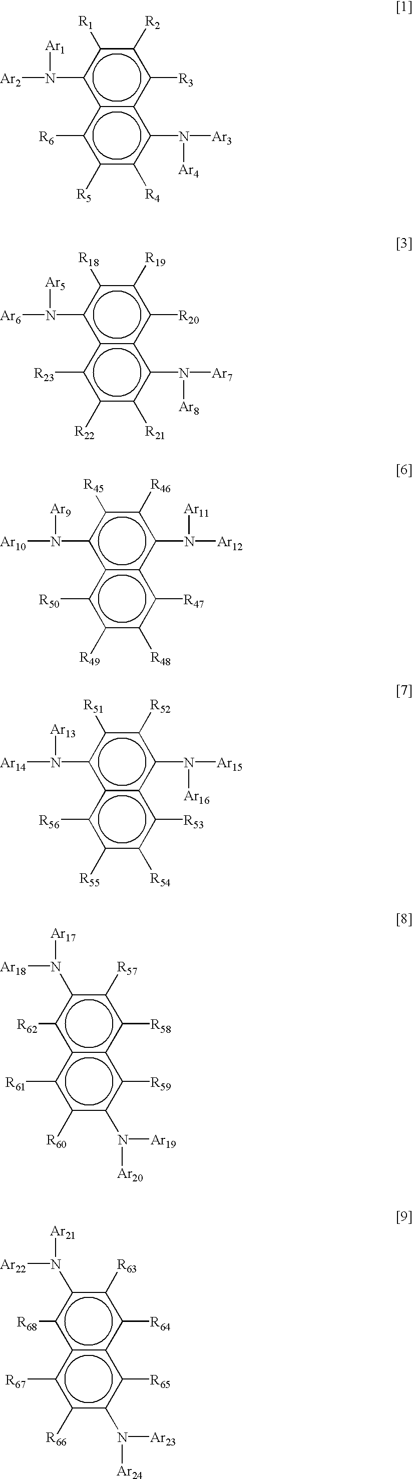

wherein Ar₁ to Ar₂₄ each independently represents a C₆₋₂₀ aryl group, R₁ to R₆₈ each independently represents a hydrogen atom, a halogen atom, a hydroxy group, a substituted or unsubstituted amino group, a nitro group, a cyano group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of each of Ar₁ to Ar₄, Ar₉ to Ar₁₂, and Ar₁₇ to Ar₂₀ represents a styryl-containing diarylamino group; at least one of each of Ar₅ to Ar₈, Ar₁₃ to Ar₁₆, and Ar₂₁ to Ar₂₄ represents a diphenylaminostyryl-containing diarylamino group; either one of R₁ and R₄, either one of R₄₅ and R₄₆, at least one of R₁₈ and R₂₁ and at least one of R₅₁ and R₅₂ each does not represent: a hydrogen atom, at least one but not all of R₅₇, R₅₉, R₆₀ and R₆₂ represents a group other than a hydrogen atom and at least one of R₆₃, R₆₅, R₆₆ and R₆₈ does not represent a hydrogen atom.

### BACKGROUND OF THE INVENTION

1. Field of the Invention

This invention relates to an organic electroluminescent device having excellent light emitting properties.

2. Description of the Prior Art

An organic electroluminescent (EL) device is a spontaneous light emitter which makes use of the principle that when an electric field is applied, a fluorescent substance emits light owing to the recombination energy of holes injected from an anode and electrons injected from a cathode. Since C. W. Tang et al. of Eastman Kodak Company made a report on a low-voltage-driven organic EL device using a laminated device (C. W. Tang, S. A. VanSlyke, Applied Physics Letters, 51, 913(1987) and the like), studies on an organic EL device using an organic material as a component have been briskly carried out. Tang, et al. employed tris(8-hydroxyquinolinol aluminum) as an emitter layer and a triphenyldiamine derivative as a hole transport layer. The laminate structure is accompanied with such advantages as an improvement in the injection efficiency of holes into an emitter layer; blocking of electrons injected from a cathode, which heightens the generation efficiency of excitons produced by the recombination; and enclosure of the excitons in the emitter layer. As an organic EL device structure, a two-layer type formed of a hole (injection) transport layer and an electron transporting emitter layer or a three-layer type formed of a hole (injection) transport layer, an emitter layer and an electron (injection) transport layer is well known. With a view to enhancing the recombination efficiency of injected holes and electrons, various improvements in the device structure or fabrication process have been added to such a device having a laminate structure.

As the hole transport material, aromatic diamine derivatives such as N,N′-diphenyl-N,N′-bis(3-methylphenyl)-[1,1′-biphenyl]-4,4′-diamine are well known (ex. Japanese Patent Application Laid-Open Nos. 20771/1996, 40995/1996, 40997/1996, 53397/1996 and 87122/1996).

As the electron transporting material, oxadiazole derivatives and triazole derivatives and the like are well known.

As the emitter material, known are chelate complexes such as tris(8-quinolinolate)aluminum complex, coumarin derivatives, tetraphenylbutadiene derivatives, bisstyrylarylene derivatives, oxadiazole derivatives and the like. Since it is reported that luminescence in a visible region from blue to red colors is available from them, industrialization of a color display device is expected (ex. Japanese Patent Application Laid-Open Nos. 239655/1996, 138561/1995, 200889/1991 and the like).

Organic EL devices using a blue-light emitting material which have so far been disclosed are however accompanied with the problems that they cannot provide blue light emission having long life, excellent color purity and high efficiency. One of the reasons for these problems is presumed that when the organic EL device comprises, in addition to an emitter layer, an electron transport layer and a hole transport layer, energy transporting from emission material to the other component materials may occur, or emission from emitting compound may affect on the other component materials. For example, if the spectrum of emission from emitting material overlaps with the absorption spectrum of the other component materials, emittion from the other component materials would arise. That is presumed to cause a change in the color emitted from the EL device and a lowering in the efficiency.

### SUMMARY OF THE INVENTION

The present inventors have carried out an extensive investigation. As a result, it has been found that an organic EL device using, in a light emitting zone, a specific bis(styryldiphenylamino)naphthalene derivative having a substituent other than a hydrogen group at the 2-position relative to the 1,5-bisdiarylamino group, at the 2-position relative to the 1,4-bisdiarylamino group, or at two or three positions of the 1-, 3-, 5- and 7-positions relative to the 2,6-bisdiarylamino group; or a specific bis(styryldiphenylamino)naphthalene derivative which has a substituent other than a hydrogen atom at the 2- and 6-positions relative to the 1,5-bisdiarylamino group, at the 2- and 3-positions relative to the 1,4-bisdiarylamino group or at the l-, 3-, 5- and 7-positions relative to the 2,6-bisdiarylamino group and at the same time, has a diphenylamino-containing styryl group emits blue light having good color purity and high efficiency, leading to the completion of the present invention.

In one aspect of the present invention, there is thus provided an organic electroluminescent device comprising an anode, a cathode and at least one emitter layer disposed between them, said emitter layer comprising, singly or as a mixture, a material represented by the following formula [1]:

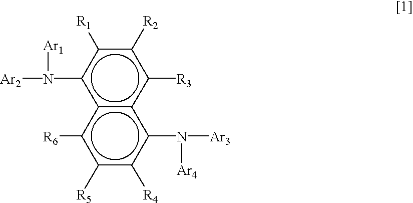

wherein Ar₁ to Ar₄ each independently represents a substituted or unsubstituted C₆₋₂₀ aryl group, with the proviso that at least one of said groups is a styryl group represented by the below-described formula [2], and optionally each of the combinations of Ar₁ and Ar₂, and Ar₃ and Ar₄ may form a ring; and R₁ to R₆ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl-group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that either one of R₁ and R₄ does not represent a hydrogen atom;

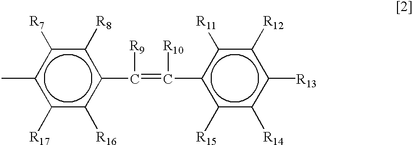

wherein R₇ to R₁₇ each independently represents a hydrogen atom, a halogen atom, a hydroxy group, a substituted or unsubstituted amino group (with the proviso that a diphenylamino group is excluded), a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

In a second aspect of the present invention, there is also provided an organic electroluminescent device comprising an anode, a cathode and at least one emitter layer disposed between them, said emitter layer comprising, singly or as a mixture, a material represented by the following formula [3]:

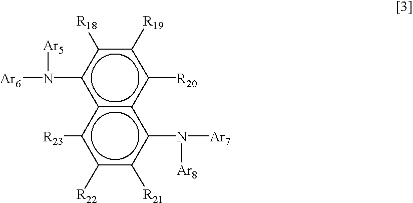

wherein Ar₅ to Ar₈ each independently represents a substituted or unsubstituted C₆₋₂₀ aryl group, with the proviso that at least one of said groups is a styryl group represented by the below-described formula [4], and optionally each of the combinations Ar₅ and Ar₆, and Ar₇ and Ar₈ may form a ring; and R₁₈ to R₂₃ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₁₈ and R₂₁ does not represent a hydrogen atom;

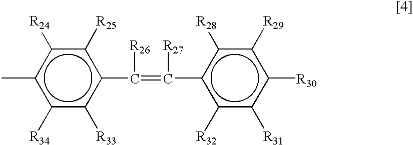

wherein R₂₄ to R₃₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₂₈ to R₃₂ represents a diphenylamino group represented by the following formula [5]:

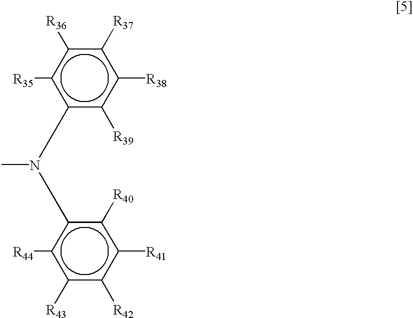

wherein R₃₅ to R₄₄ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

In a third aspect of the present invention, there is also provided an organic electroluminescent device comprising an anode, a cathode and at least one emitter layer disposed between them, said emitter layer comprising, singly or as a mixture, a material represented by the following formula [6]:

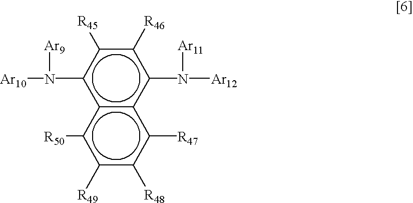

wherein Ar₉ to Ar₁₂ each independently represents a substituted or unsubstituted C₆₋₂₀ aryl group, with the proviso that at least one of said groups is a styryl group represented by the below-described formula [2], and optionally each of the combinations of Ar₉ and Ar₁₀, and Ar₁₁ and Ar₁₂ may form a ring; and R₄₅ to R₅₀ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that either one of R₄₅ and R₄₆ does not represent a hydrogen atom;

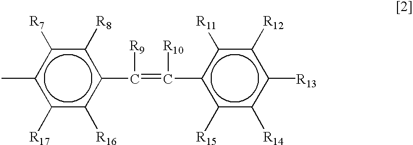

wherein R₇ to R₁₇ each independently represents a hydrogen atom, a halogen atom, a hydroxy group, a substituted or unsubstituted amino group (with the proviso that a diphenylamino group is excluded), a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

In a fourth aspect of the present invention, there is also provided an organic electroluminescent device comprising an anode, a cathode and at least one emitter layer disposed between them, said emitter layer containing, singly or as a mixture, a material represented by the following formula [7]:

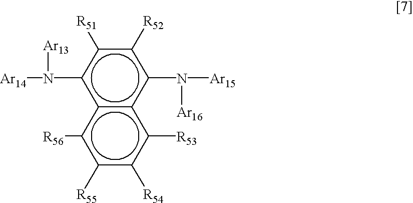

wherein Ar₁₃ to Ar₁₆ each independently represents a substituted or unsubstituted C₆₋₂₀ aryl group, with the proviso that at least one of said groups is a styryl group represented by the below-described formula [4], and optionally each of the combinations of Ar₁₃ and Ar₁₄, and Ar₁₅ and Ar₁₆ may form a ring; and R₅₁ to R₅₆ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₅₁ and R₅₂ does not represent a hydrogen atom;

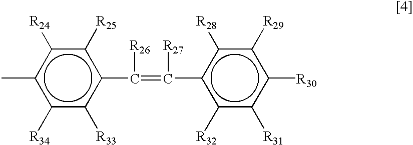

wherein R₂₄ to R₃₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₂₈ to R₃₂ represents a diphenylamino group represented by the following formula [5]:

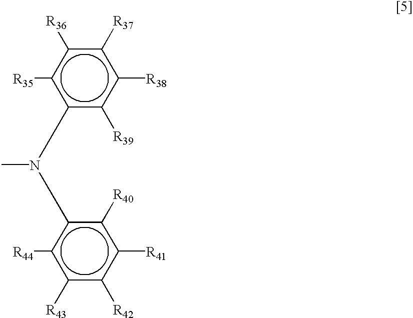

wherein R₃₅ to R₄₄ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

In a fifth aspect of the present invention, there is also provided an organic electroluminescent device comprising an anode, a cathode and at least one emitter layer disposed between them, said emitter layer comprising, singly or as a mixture, a material represented by the following formula [8]:

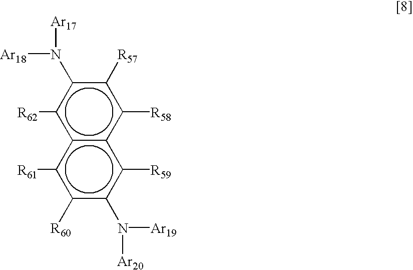

wherein Ar₁₇ to Ar₂₀ each independently represents a substituted or unsubstituted C₆₋₂₀ aryl group, with the proviso that at least one of said groups is a styryl group represented by the below-described formula [2], and optionally each of the combinations of Ar₁₇ and Ar₁₈, and Ar₁₉ and Ar₂₀ may form a ring; and R₅₇ to R₆₂ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one but not all of R₅₇, R₅₉, R₆₀ and R₆₂ represents a group other than a hydrogen atom;

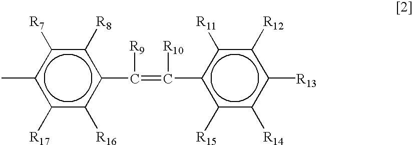

wherein R₇ to R₁₇ each independently represents a hydrogen atom, a halogen atom, a hydroxy group, a substituted or unsubstituted amino group (with the proviso that a diphenylamino group is excluded), a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

In a sixth aspect of the present invention, there is also provided an organic electroluminescent device comprising an anode, a cathode and at least one emitter layer disposed between them, said emitter layer comprising, singly or as a mixture, a material represented by the following formula [9]:

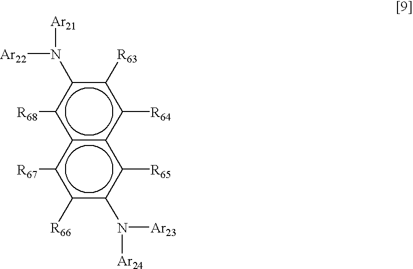

wherein Ar₂₁ to Ar₂₄ each independently represents a substituted or unsubstituted C₆₋₂₀ aryl group, with the proviso that at least one of said groups is a styryl group represented by the below-described formula [4], and optionally each of the combinations of Ar₂₁ and Ar₂₂, and Ar₂₃ and Ar₂₄ may form a ring; and R₆₃ to R₆₈ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₆₃, R₆₅, R₆₆ and R₆₈ does not represent a hydrogen atom;

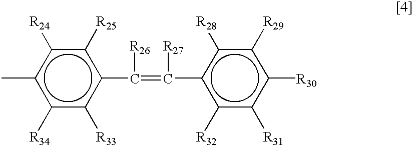

wherein R₂₄ to R₃₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of said R₂₈ to R₃₂ represents a diphenylamino group represented by the following formula [5]:

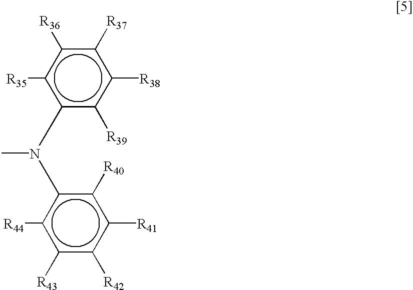

wherein R₃₅ to R₄₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

### BRIEF DESCRIPTION OF THE DRAWINGS

FIG. 1 is a cross-sectional view illustrating a device according to the present invention;

FIG. 2 is a cross-sectional view illustrating another device according to the present invention;

FIG. 3 is a cross-sectional view illustrating a further device according to the present invention; and

FIG. 4 is a cross-sectional view illustrating a still further device according to the present invention. In each diagram, indicated at numerals 1, 2, 3, 4, 5 and 6 are a substrate, an anode, a hole transport layer, an emitter layer, an electron transport layer and a cathode, respectively.

### DETAILED DESCRIPTION OF THE EMBODIMENTS

The compounds of the present invention have a structure represented by the formula [1], [6], [8], [3], [7] or [9]. In the formula [1], [6] or [8], at least one of Ar₁ to Ar₄, Ar₉ to Ar₁₂ or Ar₁₇ to Ar₂₀ is a styryl group represented by the above-described formula [2]. Each of the combinations of Ar₁ and Ar₂, Ar₃ and Ar₄, Ar₉ and Ar₁₀, Ar₁₁, and Ar₁₂, Ar₁₇ and Ar₁₈, and Ar₁₉ and Ar₂₀ may form a ring. In the formula [3], [7] or [9], at least one of Ar₅ to Ar₈, Ar₁₃ to Ar₁₆ or Ar₂₁ to Ar₂₄ is a styryl group represented by the, above-described formula [4], wherein at least one of R₂₈ to R₃₂ represents a diphenylamino group represented by the formula [5]. Each of the combinations of Ar₅ and Ar₆, Ar₇ and Ar₈, Ar₁₃ and Ar₁₄, Ar₁₅ and Ar₁₆, Ar₂₁ and Ar₂₂, and Ar₂₃ and Ar₂₄ may form a ring. In the above formulas, the group represented by each of Ar₁ to Ar₂₄ represents a substituted or unsubstituted C₆₋₃₀ aryl group. Examples of such an aryl group include monovalent groups obtained by the elimination of a hydrogen atom from aromatic hydrocarbons or condensed polycyclic hydrocarbons such as benzene, naphthalene, anthracene, phenanthrene, naphthacene, pyrene, biphenyl and terphenyl, or from heterocyclic compounds or condensed heterocyclic compounds such as carbazole, pyrrole, thiophene, furan, imidazole, pyrazole, isothiazole, isoxazole, pyridine, pyrazine, pyrimidine, pyridazine, furazane, thianthrene, isobenzofuran, phenoxazine, indolizine, indole, isoindole, 1H-indazole, purine, quinoline, isoquinoline, phthalazine, naphthylidine, quinoxaline, quinazoline, cinnoline, pteridine, carbazole, -carbazoline, phenanthridine, acridine, perimidine, phenanthroline, phenazine, phenothiazine and phenoxazine; and derivatives thereof. Examples of the compound forming the ring include a carbazolyl group. R₁ to R₆₈ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group. Examples of the substituted or unsubstituted arylene group include phenylene, naphthylene, anthrylene, phenanthrylene, naphthacenylene and pyrenylene. Examples of the halogen atom include fluorine, chlorine, bromine and iodine. The substituted or unsubstituted amino group is expressed by —NX₁X₂, wherein X₁ and X₂ each independently represents a hydrogen atom or a methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, 1,2,3-trinitropropyl, phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 4-styrylphenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl -2-yl, m-terphenyl-4-yl, m-terphenyl-3-yl, m-terphenyl -2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4′-t-butyl-p-terphenyl-4-yl, 2-pyrrolyl, 3-pyrrolyl, pyrazinyl, 2-pyridinyl, 3-pyridinyl, 4-pyridinyl, 2-indolyl, 3-indolyl, 4-indolyl, 5-indolyl, 6-indolyl, 7-indolyl, 1-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthrolin-2-yl, 1,7-phenanthrolin-3-yl, 1,7-phenanthrolin-4-yl, 1,7-phenanthrolin-5-yl, 1,7-phenanthrolin-6-yl, 1,7-phenanthrolin-8-yl, 1,7-phenanthrolin-9-yl, 1,7-phenanthrolin-10-yl, 1,8-phenanthrolin-2-yl, 1,8-phenanthrolin-3-yl, 1,8-phenanthrolin-4-yl, 1,8-phenanthrolin-5-yl, 1,8-phenanthrolin-6-yl, 1,8-phenanthrolin-7-yl, 1,8-phenanthrolin-9-yl, 1,8-phenanthrolin-1-yl, 1,9-phenanthrolin-2-yl, 1,9-phenanthrolin-3-yl, 1,9-phenanthrolin-4-yl, 1,9-phenanthrolin-5-yl, 1,9-phenanthrolin-6-yl, 1,9-phenanthrolin-7-yl, 1,9-phenanthrolin-8-yl, 1,9-phenanthrolin-10-yl, 1,10-phenanthrolin-2-yl, 1,10-phenanthrolin-3-yl, 1,10-phenanthrolin-4-yl, 1,10-phenanthrolin-5-yl, 2,9-phenanthrolin-1-yl, 2,9-phenanthrolin-3-yl, 2,9-phenanthrolin-4-yl, 2,9-phenanthrolin-5-yl, 2,9-phenanthrolin-6-yl, 2,9-phenanthrolin-7-yl, 2,9-phenanthrolin-8-yl, 2,9-phenanthrolin-10-yl, 2,8-phenanthrolin-1-yl, 2,8-phenanthrolin-3-yl, 2,8-phenanthrolin-4-yl, 2,8-phenanthrolin-5-yl, 2,8-phenanthrolin-6-yl, 2,8-phenanthrolin-7-yl, 2,8-phenanthrolin-9-yl, 2,8-phenanthrolin-10-yl, 2,7-phenanthrolin-1-yl, 2,7-phenanthrolin-3-yl, 2,7-phenanthrolin-4-yl, 2,7-phenanthrolin-5-yl, 2,7-phenanthrolin-6-yl, 2,7-phenanthrolin-8-yl, 2,7-phenanthrolin-9-yl, 2,7-phenanthrolin-10-yl, 1-phenazinyl, 2-phenazinyl, 1-phenothiazinyl, 2-phenothiazinyl, 3-phenothiazinyl, 4-phenothiazinyl, 1-phenoxazinyl, 2-phenoxazinyl, 3-phenoxazinyl, 4-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrol-1-yl, 2-methylpyrrol-3-yl, 2-methylpyrrol-4-yl, 2-methylpyrrol-5-yl, 3-methylpyrrol-1-yl, 3-methylpyrrol-2-yl, 3-methylpyrrol-4-yl, 3-methylpyrrol-5-yl, 2-t-butylpyrrol-4-yl, 3-(2-phenylpropyl)pyrrol-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl or 4-t-butyl-3-indolyl group. With regards to R₁ to R₁₇, R₄₅ to R₅₀ and R₅₇ to R₆₂, however, X₁ and X₂ do not represent aryl groups at the same time. Examples of the substituted or unsubstituted alkyl group include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl and 1,2,3-trinitropropyl groups. Examples of the substituted or unsubstituted alkenyl group include vinyl, allyl, 1-butenyl, 2-butenyl, 3-butenyl, 1,3-butanedienyl, 1-methylvinyl, styryl, 4-diphenylaminostyryl, 4-di-p-tolylaminostyryl, 4-di-m-tolylaminostyryl, 2,2-diphenylvinyl, 1,2-dipheylvinyl, 1-methylallyl, 1,1-dimethylallyl, 2-methylallyl, 1-phenylallyl, 2-phenylallyl, 3-phenylallyl, 3,3-diphenylallyl, 1,2-dimethylallyl, 1-phenyl-1-butenyl and 3-phenyl-1-butenyl groups. Examples of the substituted or unsubstituted cycloalkyl group include cyclopropyl, cyclobutyl, cyclopentyl, cyclohexyl and 4-methylcyclohexyl groups. The substituted or unsubstituted alkoxy group is a group represented by —OY, wherein Y represents an ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl or 1,2,3-trinitropropyl group. Example of the substituted and unsubstituted aromatic hydrocarbon group include phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl -4-yl, p-terphenyl-3-yl, p-terphenyl-2-yl, m-terphenyl -4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl -4-yl groups. Examples of the substituted or unsubstituted aromatic heterocyclic group include 1-pyrrolyl, 2-pyrrolyl, 3-pyrrolyl, pyrazinyl, 2-pyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthrolin-2-yl, 1,7-phenanthrolin-3-yl, 1,7-phenanthrolin-4-yl, 1,7-phenanthrolin-5-yl, 1,7-phenanthrolin-6-yl, 1,7-phenanthrolin-8-yl, 1,7-phenanthrolin-9-yl, 1,7-phenanthrolin-10-yl, 1,8-phenanthrolin-2-yl, 1,8-phenanthrolin-3-yl, 1,8-phenanthrolin-4-yl, 1,8-phenanthrolin-5-yl, 1,8-phenanthrolin-6-yl, 1,8-phenanthrolin-7-yl, 1,8-phenanthrolin-9-yl, 1,8-phenanthrolin-10-yl, 1,9-phenanthrolin-2-yl, 1,9-phenanthrolin-3-yl, 1,9-phenanthrolin-4-yl, 1,9-phenanthrolin-5-yl, 1,9-phenanthrolin-6-yl, 1,9-phenanthrolin-7-yl, 1,9-phenanthrolin-8-yl, 1,9-phenanthrolin-10-yl, 1,10-phenanthrolin-2-yl, 1,10-phenanthrolin-3-yl, 1,10-phenanthrolin-4-yl, 1,10-phenanthrolin-5-yl, 2,9-phenanthrolin-1-yl, 2,9-phenanthrolin-3-yl, 2,9-phenanthrolin-4-yl, 2,9-phenanthrolin-5-yl, 2,9-phenanthrolin-6-yl, 2,9-phenanthrolin-7-yl, 2,9-phenanthrolin-8-yl, 2,9-phenanthrolin-10-yl, 2,8-phenanthrolin-1-yl, 2,8-phenanthrolin-3-yl, 2,8-phenanthrolin-4-yl, 2,8-phenanthrolin-5-yl, 2,8-phenanthrolin-6-yl, 2,8-phenanthrolin-7-yl, 2,8-phenanthrolin-9-yl, 2,8-phenanthrolin-10-yl, 2,7-phenanthrolin-1-yl, 2,7-phenanthrolin-3-yl, 2,7-phenanthrolin-4-yl, 2,7-phenanthrolin-5-yl, 2,7-phenanthrolin-6-yl, 2,7-phenanthrolin-8-yl, 2,7-phenanthrolin-9-yl, 2,7-phenanthrolin-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrol-1-yl, 2-methylpyrrol -3-yl, 2-methylpyrrol-4-yl, 2-methylpyrrol-5-yl, 3-methylpyrrol-1-yl, 3-methylpyrrol-2-yl, 3-methylpyrrol-4-yl, 3-methylpyrrol-5-yl, 2-t-butylpyrrol-4-yl, 3-(2-phenylpropyl)pyrrol-1-yl, 2-methyl-1-indolyl, 4-methyl-1-indolyl, 2-methyl-3-indolyl, 4-methyl-3-indolyl, 2-t-butyl -1-indolyl, 4-t-butyl-1-indolyl, 2-t-butyl-3-indolyl and 4-t-3-butyl-3-indolyl groups. Examples of the substituted or unsubstituted aralkyl group include benzyl, 1-phenylethyl, 2-phenylethyl, 1-phenylisopropyl, 2-phenylisopropyl, phenyl-t-butyl, -naphthylmethyl, 1-naphthylethyl, 2-naphthylethyl, 1-naphthylisopropyl, 2-naphthylisopropyl, -naphthylmethyl, 1-naphthylethyl, 2-naphthylethyl, 1-naphthylisopropyl, 2-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl and 1-chloro-2-phenylisopropyl groups. The substituted or unsubstituted aryloxy group is represented by —OZ. Examples of the Z include phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl -4-yl, p-terphenyl-3-yl, p-terphenyl-2-yl, m-terphenyl -4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl -4-yl, 2-pyrrolyl, 3-pyrrolyl, pyrazinyl, 2-pyridinyl, 3-pyridinyl, 4-pyridinyl, 2-indolyl, 3-indolyl, 4-indolyl, 5-indolyl, 6-indolyl, 7-indolyl, 1-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthrolin-2-yl, 1,7-phenanthrolin-3-yl, 1,7-phenanthrolin-4-yl, 1,7-phenanthrolin-5-yl, 1,7-phenanthrolin-6-yl, 1,7-phenanthrolin-8-yl, 1,7-phenanthrolin-9-yl, 1,7-phenanthrolin-10-yl, 1,8-phenanthrolin-2-yl, 1,8-phenanthrolin-3-yl, 1,8-phenanthrolin-4-yl, 1,8-phenanthrolin-5-yl, 1,8-phenanthrolin-6-yl, 1,8-phenanthrolin-7-yl, 1,8-phenanthrolin-9-yl, 1,8-phenanthrolin-10-yl, 1,9-phenanthrolin-2-yl, 1,9-phenanthrolin-3-yl, 1,9-phenanthrolin-4-yl, 1,9-phenanthrolin-5-yl, 1,9-phenanthrolin-6-yl, 1,9-phenanthrolin-7-yl, 1,9-phenanthrolin-8-yl, 1,9-phenanthrolin-10-yl, 1,10-phenanthrolin-2-yl, 1,10-phenanthrolin-3-yl, 1,10-phenanthrolin-4-yl, 1,10-phenanthrolin-5-yl, 2,9-phenanthrolin-1-yl, 2,9-phenanthrolin-3-yl, 2,9-phenanthrolin-4-yl, 2,9-phenanthrolin-5-yl, 2,9-phenanthrolin-6-yl, 2,9-phenanthrolin-7-yl, 2,9-phenanthrolin-8-yl, 2,9-phenanthrolin-10-yl, 2,8-phenanthrolin-1-yl, 2,8-phenanthrolin-3-yl, 2,8-phenanthrolin-4-yl, 2,8-phenanthrolin-5-yl, 2,8-phenanthrolin-6-yl, 2,8-phenanthrolin-7-yl, 2,8-phenanthrolin-9-yl, 2,8-phenanthrolin-10-yl, 2,7-phenanthrolin-1-yl, 2,7-phenanthrolin-3-yl, 2,7-phenanthrolin-4-yl, 2,7-phenanthrolin-5-yl, 2,7-phenanthrolin-6-yl, 2,7-phenanthrolin-8-yl, 2,7-phenanthrolin-9-yl, 2,7-phenanthrolin-10-yl, 1-phenazinyl, 2-phenazinyl, 1-phenothiazinyl, 2-phenothiazinyl, 3-phenothiazinyl, 4-phenothiazinyl, 1-phenoxazinyl, 2-phenoxazinyl, 3-phenoxazinyl, 4-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrol-1-yl, 2-methylpyrrol -3-yl, 2-methylpyrrol-4-yl, 2-methylpyrrol-5-yl, 3-methylpyrrol-1-yl, 3-methylpyrrol-2-yl, 3-methylpyrrol-4-yl, 3-methylpyrrol-5-yl, 2-t-butylpyrrol-4-yl, 3-(2-phenylpropyl)pyrrol-1-yl, 2-methyl-1-indolyl, 4-methyl-1-indolyl, 2-methyl-3-indolyl, 4-methyl-3-indolyl, 2-t-butyl -1-indolyl, 4-t-butyl-1-indolyl, 2-t-butyl-3-indolyl and 4-t-butyl-3-indolyl groups. The substituted or unsubstituted alkoxycarbonyl group is represented by —COOY. Examples of the Y include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl and 1,2,3-trinitropropyl groups. Examples of the compound having a structure represented by the formula [1], [6], [8], [3], [7] or [9] will be given below. It should however be noted that the present invention is not limited to or by them.

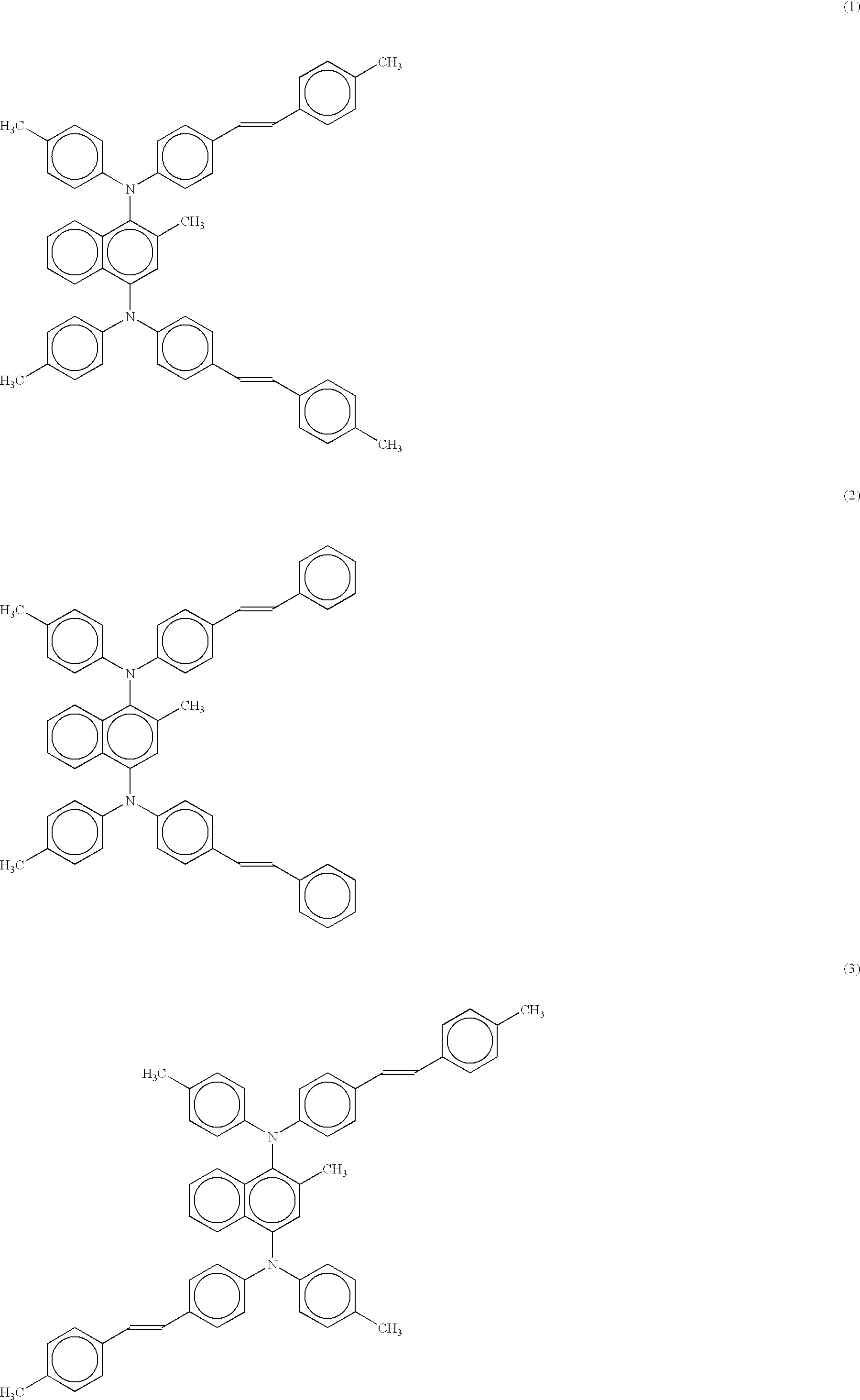

For example, the compound represented by the above-described formula (1) can provide blue light emission having excellent color purity, because compared with a compound having a naphthalene ring all substituted with a hydrogen atom, it does not cause unnecessary interaction with another component. Such effects have been brought about for the first time by the introduction of a substituent into the naphthalene ring. The compound having a substituent at any other position did not exhibit such effects.

Compared with a device using a compound which has a naphthalene ring all substituted with a hydrogen atom and does not have a diphenylamino group at the end of a styryl group as a light emitting material, a device using the compound represented by the above-described formula (9) as a light emitting material (1) does not cause unnecessary interaction with another component so that blue light emission with excellent color purity can be obtained; and (2) has excellent hole transporting properties so that light emission can be obtained at high efficiency. Effects of (1) and (2) above are presumed to be synergistically brought about by the introduction of a substituent into the naphthalene ring and introduction of a diphenylamino group into the end of the styryl group.

The compound represented by the formula [1] or [3] can be synthesized in a conventionally known synthetic reaction. For example, a triphenylamine derivative can be synthesized by the Ullmann reaction of a diaminoarylene with a benzene halide, the Ullmann reaction of an arylene dihalide and an aromatic amine, or the like. A styryl derivative can be obtained by synthesizing the corresponding aldehyde and phosphonate and then subjecting them to the Wittig-Hornor reaction.

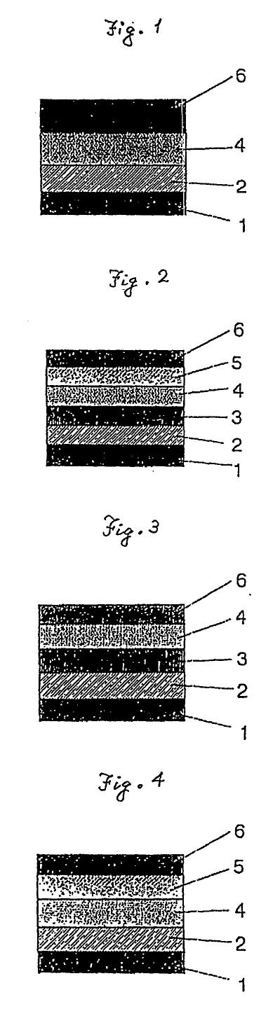

The organic EL device according to the present invention has a laminate structure having one or more than one organic layers stacked between electrodes. As shown in FIGS. 1 to 4, the laminate structure is formed of, for example, (1) an anode, an emitter layer and a cathode; (2) an anode, a hole transport layer, an emitter layer, an electron transport layer and a cathode; (3) an anode, a hole transport layer, an emitter layer and a cathode; or (4) an anode, an emitter layer, an electron transport layer and a cathode. The compound of the present invention may be used, singly or as a mixture, for any one of the above-described organic layers. It is also possible to dope the compound into another hole transport material, emitter material or electron transport material.

There is no particular limitation imposed on the hole transport material to be used in the present invention. Any compound ordinarily employed as a hole transport material may be used. Examples include triphenyldiamines such as bis(di(p-tolyl)aminophenyl)-1,1-cyclohexane [01], N,N′-diphenyl-N,N′-bis(3-methylphenyl)-1,1′-biphenyl-4,4′-diamine [02] and N,N′-diphenyl-N-N-bis (1-naphthyl)-1,1′-biphenyl)-4,4′-diamine [03] and starburst type molecules ([04] to [06]).

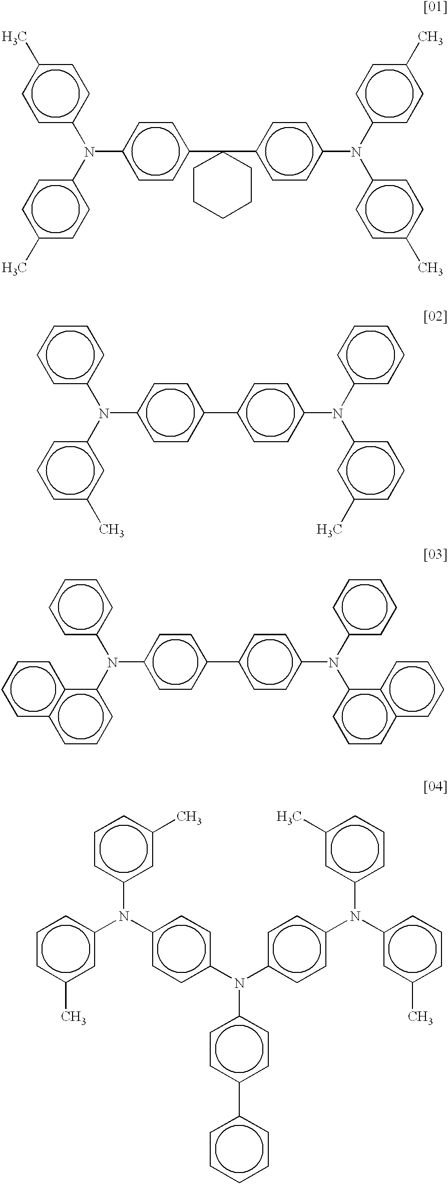

There is no particular limitation imposed on the electron transport material to be used in the present invention. Any material employed ordinarily as an electron transport material can be employed. Examples include oxadiazole derivatives such as 2-(4-biphenylyl)-5-(4-t-butylphenyl)-1,3,4-oxadiazole [07] and bis{2-(4-t-butylphenyl)-1,3,4-oxadiazole}-m-phenylene [08], triazole derivatives ([09], [10] and the like) and quinolinol type metal complexes ([11] to [14] and the like).

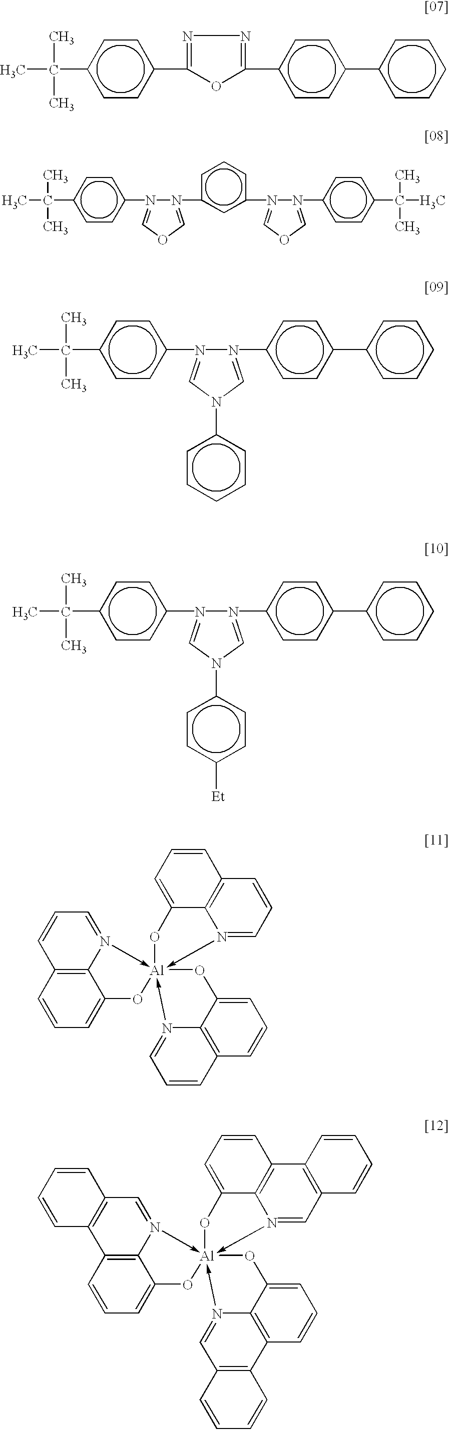

The anode of the organic thin-film EL device plays a role of injecting holes into the hole transport layer and that having a work function of 4.5 eV or greater is effective. Specific examples of the anode material to be used in the present invention include an indium oxide-tin alloy (ITO), tin oxide (NESA), gold, silver, platinum and copper. For injection of electrons into the electron transport layer or emitter layer, the cathode having a smaller work function is preferred. Although there is no particular limitation imposed on the cathode material, specific examples include indium, aluminum, magnesium, magnesium-indium alloy, magnesium-aluminum alloy, aluminum-lithium alloy, aluminum-scandium-lithium alloy and magnesium-silver alloy.

There is no particular limitation imposed on the forming method of each layer of the organic EL device of the present invention. Conventionally known methods such as vacuum deposition and spin coating can be employed. An organic thin-film layer which is to be used in the organic EL device of the present invention and contains the compound having a structure represented by the formula [1], [6], [8], [3], [7] or [9] can be formed by a known method such as vacuum deposition, molecular beam evaporation (MBE) or coating of a solution of the compound dissolved in a solvent by dipping, spin coating, casting, bar coating or roll coating.

There is no particular limitation imposed on the thickness of each of the organic layers of the organic EL device of the present invention. When the film is too thin, however, defects such as pin holes tend to occur. When the film is too thick, on the other hand, a high applied voltage is required, which deteriorates the efficiency. Usually, the organic layers are therefore preferred to have a film thickness within a range of several-nm to 1 μm.

### EXAMPLES

The present invention will hereinafter be described in detail by examples. It should however be borne in mind that the present invention is not limited only to the following examples so long as they do not depart from the spirit or scope of the invention.

### Synthesis Example 1

### Synthesis of Compound (1)

In a three-necked flask purged with argon, 1,4-dibromo-2-methylnaphthalene, 4-methyldiphenylamine, potassium carbonate and copper powder were charged, followed by stirring at 200° C. for 30 hours. After completion of the reaction, the reaction mixture was diluted with toluene and subjected to suction filtration to remove the inorganic salt. After the organic phase was washed once with water and dried over magnesium sulfate, it was separated and purified by chromatography on a silica gel column using a 1:2 (volume ratio) mixed solvent of toluene and ligroin, followed by reprecipitation with a mixed solvent of toluene and ethanol, whereby 1,4-bis(4-methyldiphenylamino)-2-methylnaphthalene was obtained as a yellow powder.

To a solution of the resulting 1,4-bis(4-methyldiphenylamino)-2-methylnaphthalene in toluene, phosphorus oxychloride and N-methylformanilide were added, followed by stirring at 60° C. for 6 hours. After completion of the reaction, cooled water was poured and the mixture was transferred to a separatory funnel, in which the mixture was washed with water until it became neutral. The neutralized mixture was then dried over magnesium sulfate and separated and purified by chromatography on a silica gel column using a 5:1 (volume ratio) mixed solvent of toluene and ethyl acetate, whereby 1,4-bis(4-methyl-4′-formyldiphenylamino)-2methylnaphthalene was obtained.

In a three-necked flask purged with argon, dimethylsulfoxide was charged, in which sodium hydride was dispersed. To the resulting dispersion, diethyl 4-methylbenzylphosphonate was added, followed by the dropwise addition of a solution of the above-obtained 1,4-bis(4-methyl-4′-formyldiphenylamino)-2-methylnaphthalene in dimethylsulfoxide while stirring. The mixture was stirred at 40° C. for 5 hours. After completion of the reaction, cooled water was poured and the mixture was transferred to a separatory funnel, in which the mixture was washed with water until it became neutral. After drying over magnesium sulfate, the mixture was separated and purified by chromatography on a silica gel column using a 1:2 (volume ratio) mixed solvent of toluene and ligroin, followed by reprecipitation with a mixed solvent of toluene and ethanol, whereby 1,4-bis(4-(4-methylbenzyl)-4′-methyldiphenylamino)-2-methylnaphthalene [Compound (1)] was obtained.

### Synthesis Example 2

### Synthesis of Compound (7)

In a three-necked flask purged with argon, 1,5-dibromo-2,6-dimethylnaphthalene, 4-methyldiphenylamine, potassium carbonate and copper powder were charged, followed by stirring at 200° C. for 30 hours. After completion of the reaction, the reaction mixture was diluted with toluene and subjected to suction filtration to remove the inorganic salt. After the organic layer was washed once with water and dried over magnesium sulfate, it was separated and purified by chromatography on a silica gel column using a 1:2 (volume ratio) mixed solvent of toluene and ligroin, followed by reprecipitation with a mixed solvent of toluene and ethanol, whereby 1,5-bis(4-methyldiphenylamino)-2,6-dimethylnaphthalene was obtained as a yellow powder.

To a solution of the resulting 1,5-bis(4-methyldiphenylamino)-2,6-dimethylnaphthylene in toluene, phosphorus oxychloride and N-methylformanilide were added, followed by stirring at 60° C. for 6 hours. After completion of the reaction, cooled water was poured and the mixture was transferred to a separatory funnel, in which the mixture was washed with water until it became neutral. The mixture was then dried over magnesium sulfate, and then separated and purified by chromatography on a silica gel column using a 5:1 (volume ratio) mixed solvent of toluene and ethyl acetate, whereby 1,5-bis(4-methyl-4′-formyldiphenylamino)-2,6-dimethylnaphthalene was obtained.

In a three-necked flask purged with argon, dimethylsulfoxide was charged, in which sodium hydride was dispersed. To the resulting dispersion, diethyl 4-di-p-tolylaminobenzylphosphonate was added, followed by the dropwise addition of a solution of the above-obtained 1,5-bis(4-methyl-4′-formyldiphenylamino)-2,6-dimethylnaphthalene in dimethylsulfoxide while stirring. The mixture was stirred at 40° C. for 5 hours. After completion of the reaction, cooled water was poured and the mixture was transferred to a separatory funnel in which the mixture was washed with water until it became neutral. After drying over magnesium sulfate, the mixture was separated and purified by chromatography on a silica gel column using a 1:2 (volume ratio) mixed solvent of toluene and ligroin, followed by reprecipitation with a mixed solvent of toluene and ethanol, whereby 1,5-bis(4-(4-di-p-tolylaminobenzyl)-4′-methyldiphenylamino)-2,6-dimethylnaphthalene [Compound (7)] was obtained.

The use of the invention compound as an emitter layer (Examples 1 to 12, 17 to 22, 27 to 30), the use of a mixed thin-film of the invention compound and a hole transport material as an emitter layer (Examples 13 to 16) and use of a mixed thin-film of the invention compound and an electron transport material as an emitter layer (Examples 23 to 26) will hereinafter be exemplified.

### Example 1

A cross-sectional structure of the device used in Example 1 is shown in FIG. 1. The fabrication procedure of the organic thin-film EL device to be used in Example 1 will next be described. The device is formed of an anode, an emitter layer and a cathode. First, a film having a sheet resistance of 20/was formed as the anode by sputtering ITO on a glass substrate. Over the anode, the emitter layer was formed to a thickness of 40 nm by the vacuum deposition of Compound (1). Then, the cathode was formed to a thickness of 200 nm over the emitter layer by the vacuum deposition of a magnesium-silver alloy, whereby the organic EL device was fabricated. When dc voltage of 5V was applied to the resulting device, blue light emission of 200 cd/m² was obtained. Its maximum luminescent efficiency was found to be 0.5 lm/W.

### Example 2

In a similar manner to Example 1 except that Compound (3) was used instead as the light emitting material, an organic EL device was fabricated. When dc voltage of 5V was applied to the resulting organic EL device, blue light emission of 210 cd/m² was obtained. Its maximum luminescent efficiency was found to be 0.6 lm/W.

### Example 3

A film having a sheet resistance of 20/was formed as an anode by sputtering ITO on a glass substrate. Over the anode, an emitter layer was formed to a thickness of 40 nm by spin coating of a solution of Compound (5) in chloroform. Then, a cathode was formed thereover to a thickness of 200 nm by the vacuum deposition of a magnesium-silver alloy, whereby an organic EL device was fabricated. When dc voltage of 5V was applied to the resulting device, blue light emission of 180 cd/m² was obtained. Its maximum luminescent efficiency was found to be 0.5 lm/W.

### Example 4

The cross-sectional structure of the device used in Example 4 is shown in FIG. 2. The device is formed of an anode, a hole transport layer, an emitter layer, an electron transport layer and a cathode. A film having a sheet resistance of 20/was formed as the anode by sputtering ITO on a glass substrate, followed by the formation of the hole transport layer thereover to a thickness of 50 nm by the vacuum deposition of Compound [03]. Then, the emitter layer was formed to a thickness of 40 nm by the vacuum deposition of Compound (2). On the emitter layer, the electron transport layer was formed to a thickness of 20 nm by the vacuum deposition of Compound [09]. The cathode was then formed to a thickness of 200 nm by the vacuum deposition of a magnesium-silver alloy, whereby the organic EL device was fabricated. When dc voltage of 10V was applied to the resulting organic EL device, blue light emission of 12,000 cd/m² was obtained. Its maximum luminescent efficiency was found to be 4.5 lm/W.

### Example 5

In a similar manner to Example 4 except for the use of Compound (4) as the light emitting material, an organic EL device was fabricated. When dc voltage of 10V was applied to the resulting organic EL device, blue light emission of 10,000 cd/m² was obtained. Its maximum luminescent efficiency was found to be 4.8 lm/W.

### Example 6

In a similar manner to Example 4 except for the use of Compound [01] and Compound [08] as the hole transport layer and electron transport layer, respectively, an organic EL device was fabricated. When dc voltage of 10V was applied to the resulting organic EL device, blue light emission of 13,000 cd/m2 was obtained. Its maximum luminescent efficiency was found to be 4.5 lm/W.

### Example 7

The cross-sectional structure of the device used in Example 7 is shown in FIG. 1. The fabrication procedure of the organic EL device used in Example 7 of the present invention will next be described. The device is formed of an anode, an emitter layer and a cathode. A film having a sheet resistance of 20/was formed as the anode by sputtering ITO on a glass substrate, followed by the formation of the emitter layer to a thickness of 40 nm by the vacuum deposition of Compound (7). Over the emitter layer, the cathode was formed to a thickness of 200 nm by the vacuum deposition of a magnesium-silver alloy, whereby the organic EL device was fabricated. When dc voltage of 12V was applied to the resulting organic EL device, blue light emission of 180 cd/m² was obtained. Its maximum luminescent efficiency was found to be 0.3 lm/W.

### Example 8

In a similar manner to Example 7 except for the use of Compound (10) as the light emitting material, an organic EL device was fabricated. When dc voltage of 12V was applied to the resulting organic EL device, blue light emission of 250 cd/m² was obtained. Its maximum luminescent efficiency was found to be 0.4 lm/W.

### Example 9

A film having a sheet resistance of 20/was formed as an anode by sputtering ITO on a glass substrate. Over the anode, an emitter layer was formed to a thickness of 40 nm by spin coating of a solution of Compound (11) in chloroform. A cathode was then formed thereover to a thickness of 200 nm by the vacuum deposition of a magnesium-silver alloy, whereby an organic EL device was fabricated. When dc voltage of 12V was applied to the resulting organic EL device, blue light emission of 180 cd/m² was obtained. Its maximum luminescent efficiency was found to be 0.31 lm/W.

### Example 10

The cross-sectional structure of the device used in Example 10 is shown in FIG. 2. The device is formed of an anode, a hole transport layer, an emitter layer, an electron transport layer and a cathode. A film having a sheet resistance of 20/was formed as the anode by sputtering ITO on a glass substrate, followed by the formation of the hole transport layer to a thickness of 50 nm by the vacuum deposition of Compound [03]. Then, the emitter layer was formed to a thickness of 40 nm by the vacuum deposition of Compound (8). Over the emitter layer, the electron transport layer was formed to a thickness of 20 nm by the vacuum deposition of Compound [09], followed by the formation of the cathode thereover to a thickness of 200 nm by the vacuum deposition of a magnesium-silver alloy, whereby the organic EL device was fabricated. When dc voltage of 10V was applied to the resulting organic EL device, blue light emission of 10,000 cd/m² was obtained. Its maximum luminescent efficiency was found to be 4.3 lm/W.

### Example 11

In a similar manner to Example 10 except for the use of Compound (10) as the light emitting material, an organic EL device was fabricated. When dc voltage of 10V was applied to the resulting organic EL device, blue light emission of 11,000 cd/m² was obtained. Its maximum luminescent efficiency was found to be 4.1 lm/W.

### Example 12

In a similar manner to Example 10 except for the use of Compound [01] as the hole transport layer and Compound [08] as the electron transport layer, an organic EL device was fabricated. When dc voltage of 10V was applied to the resulting organic EL device, blue light emission of 12,000 cd/m² was obtained. Its maximum luminescent efficiency was found to be 4.2 lm/W.

### Example 13

The cross-sectional structure of the device used in Example 13 is shown in FIG. 4. The device is composed of an anode, an emitter layer, an electron transport layer and a cathode. A film having a sheet resistance of 20/was formed as the anode by sputtering ITO on the glass substrate. Over the anode, Compound [03] and Compound (1) were co-deposited at a weight ratio of 1:10 to form a thin film having a thickness of 50 nm as the emitter layer. Then, the electron transport layer was formed to a thickness of 50 nm by the vacuum deposition of Compound [09], followed by the formation of the cathode to a thickness of 200 nm thereover by the vacuum deposition of a magnesium-silver alloy, whereby the organic EL device was fabricated. When dc voltage of 10V was applied to the resulting device, blue light emission of 5,000 cd/m² was obtained. Its maximum luminescent efficiency was found to be 2.5 lm/W.

### Example 14

In a similar manner to Example 13 except for the use of Compound (5) instead of Compound (1), an organic EL device was fabricated. When dc voltage of 10V was applied to the resulting device, blue light emission of 7,200 cd/m² was obtained. Its maximum luminescent efficiency was found to be 2.4 lm/W.

### Example 15

The cross-sectional structure of the device used in Example 15 is shown in FIG. 4. The device is composed of an anode, an emitter layer, an electron transport layer and a cathode. A film having a sheet resistance of 20/was formed as the anode by sputtering ITO on the glass substrate. Over the anode, Compound [03] and Compound (8) were co-deposited at a weight ratio of 1:10 to form a thin film having a thickness of 50 nm as the emitter layer. Then, a film of 50 nm in thickness was formed as the electron transport layer by the vacuum deposition of Compound [09], followed by the formation of the cathode thereover to a thickness of 200 nm by the vacuum deposition of a magnesium-silver alloy, whereby the organic EL device was fabricated. When dc voltage of 10V was applied to the resulting device, blue light emission of 5,000 cd/m² was obtained. Its maximum luminescent efficiency was found to be 2.3 lm/W.

### Example 16

In a similar manner to Example 15 except for the use of Compound (11) instead of Compound (8), an organic EL device was fabricated. When dc voltage of 10V was applied to the resulting device, blue light emission of 7,500 cd/m² was obtained. Its maximum luminescent efficiency was found to be 2.2 lm/W.

### Example 17

A film having a sheet resistance of 20/was formed as the anode by sputtering ITO on the glass substrate. Over the anode, an emitter layer was formed to a thickness of 80 nm by the vacuum deposition of Compound (3), followed by the formation of an electron transport layer thereover to a thickness of 50 nm by the vacuum deposition of Compound [08]. Then, a film was formed to a thickness of 200 nm as the cathode by the vacuum deposition of a magnesium-silver alloy, whereby an organic EL device was fabricated. When dc voltage of 10V was applied to the resulting device, blue light emission of 8,000 cd/m² was obtained. Its maximum luminescent efficiency was found to be 4.2 lm/W.

### Example 18

In a similar manner to Example 17 except for the use of Compound (5) instead of Compound (3), an organic EL device was fabricated. When dc voltage of 10V was applied to the resulting device, blue light emission of 9,200 cd/m² was obtained. Its maximum luminescent efficiency was found to be 2.4 lm/W.

### Example 19

In a similar manner to Example 17 except Compound (1) was used instead of Compound (3) and Compound [09] was employed as the electron transport layer, an organic EL device was fabricated. When dc voltage of 10V was applied to the resulting device, blue light emission of 9,200 cd/m² was obtained. Its maximum luminescent efficiency was found to be 2.8 lm/W.

### Example 20

A film having a sheet resistance of 20/was formed as the anode by sputtering ITO on a glass substrate. Over the anode, an emitter layer was formed to a thickness of 80 nm by the vacuum deposition of Compound (9). An electron transport layer was then formed to a thickness of 50 nm by the vacuum deposition of Compound [08]. A film was formed thereover to a thickness of 200 nm as the cathode by the vacuum deposition of a magnesium-silver alloy, whereby the organic EL device was fabricated. When dc voltage of 10V was applied to the resulting device, blue light emission of 7,000 cd/m² was obtained. Its maximum luminescent efficiency was found to be 3.5 lm/W.

### Example 21

In a similar manner to Example 20 except for the use of Compound (11) instead of Compound (9), an organic EL device was fabricated. When dc voltage of 10V was applied to the resulting device, blue light emission of 7,200 cd/m² was obtained. Its maximum luminescent efficiency was found to be 3.7 lm/W.

### Example 22

In a similar manner to Example 20 except that Compound (7) was used instead of Compound (9) and Compound [09] was employed as the electron transport layer, an organic EL device was fabricated. When dc voltage of 10V was applied to the resulting device, blue light emission of 9,500 cd/m² was obtained. Its maximum luminescent efficiency was found to be 3.5 lm/W.

### Example 23

The cross-sectional structure of the device used in Example 23 is shown in FIG. 3. The device is composed of an anode, a hole transport layer, an emitter layer and a cathode. A film having a sheet resistance of 20/was formed as the anode by sputtering ITO on the glass substrate. Over the anode, a film was formed to a thickness of 50 nm as the hole transport layer by the vacuum deposition of Compound [03]. Compound [11] and Compound (1) were co-deposited at a weight ratio of 20:1 to form a film having a thickness of 50 nm as the emitter layer, followed by the formation of the cathode to a thickness of 200 nm by the vacuum deposition of a magnesium-silver alloy, whereby the organic EL device was fabricated. When dc voltage of 10V was applied to the resulting device, blue light emission of 5,500 cd/m² was obtained. Its maximum luminescent efficiency was found to be 2.2 lm/W.

### Example 24

In a similar manner to Example 23 except for the use of an emitter layer of 50 nm in thickness formed by the vacuum co-deposition of Compound [11] and Compound (2) at a weight ratio of 20:1, an organic EL device was fabricated. When dc voltage of 10V was applied to the resulting device, blue light emission of 6,000 cd/m² was obtained. Its maximum luminescent efficiency was found to be 2.1 lm/W.

### Example 25

The cross-sectional structure of the device used in Example 25 is shown in FIG. 3. The device is composed of an anode, a hole transport layer, an emitter layer and a cathode. A film having a sheet resistance of 20/was formed as the anode by sputtering ITO on the glass substrate. Over the anode, a film of 50 nm in thickness was formed as the hole transport layer by the vacuum deposition of Compound [03]. Then, Compound [11] and Compound (7) were co-deposited at a weight ratio of 20:1 to form the emitter layer of 50 nm in thickness, followed by the formation of the anode to a thickness of 200 nm over the emitter layer by the vacuum deposition of a magnesium-silver alloy, whereby the organic EL device was fabricated. When dc voltage of 10V was applied to the resulting device, blue light emission of 5,500 cd/m² was obtained. Its maximum luminescent efficiency was found to be 2.8 lm/W.

### Example 26

In a similar manner to Example 25 except for the use of a film of 50 nm in thickness formed by the vacuum co-deposition of Compound [11] and Compound (11) at a weight ratio of 20:1 as the emitter layer, an organic EL device was fabricated. When dc voltage of 10V was applied to the resulting device, blue light emission of 6,000 cd/m² was obtained. Its maximum luminescent efficiency was found to be 2.5 lm/W.

### Example 27

A film having a sheet resistance of 20/was formed as an anode by sputtering ITO on a glass substrate. Over the anode, a film of 50 nm was formed as a hole transport layer by the vacuum deposition of Compound [03]. A film of 40 nm was then formed thereover as an emitter layer by the vacuum deposition of Compound (2), followed by the formation of a cathode to a thickness of 200 nm over the emitter layer by the vacuum deposition of a magnesium-silver alloy, whereby an organic EL device was fabricated. When dc voltage of 10V was applied to the resulting device, blue light emission of 4,000 cd/m² was obtained. Its maximum luminescent efficiency was found to be 1.3 lm/W.

### Example 28

In a similar manner to Example 27 except for the use of Compound [01] for the hole transport layer and Compound (4) for the emitter layer, an organic EL device was fabricated. When dc voltage of 10V was applied to the resulting device, blue light emission of 4,100 cd/m² was obtained. Its maximum luminescent efficiency was found to be 1.2 lm/W.

### Example 29

A film having a sheet resistance of 20/was formed as an anode by sputtering ITO on a glass substrate. Over the anode, a film was formed to a thickness of 50 nm as a hole transport layer by the vacuum deposition of Compound [03]. An emitter layer was then formed to a thickness of 40 nm by the vacuum deposition of Compound (8), followed by the formation of a cathode of 200 nm in thickness over the emitter layer by the vacuum deposition of a magnesium-silver alloy, whereby an organic EL device was fabricated. When dc voltage of 10V was applied to the resulting device, blue light emission of 3,600 cd/m² was obtained. Its maximum luminescent efficiency was found to be 2.1 lm/W.

### Example 30

In a similar manner to Example 29 except for the use of Compound [01] for the hole transport layer and Compound (12) for the emitter layer, an organic EL device was fabricated. When dc voltage of 10V was applied to the resulting device, blue light emission of 4,600 cd/m² was obtained. Its maximum luminescent efficiency was found to be 2.0 lm/W.

As described above, by the use of the invention compound in a light emitting zone of an organic EL device, blue light emission with excellent color purity and high brightness can be obtained. The present invention therefore brings about great advantages.

What is claimed is:

1. An organic electroluminescent device comprising an anode, a cathode and at least one emitter layer disposed between them, said emitter layer comprising, singly or as a mixture, a material represented by the following formula [1]: 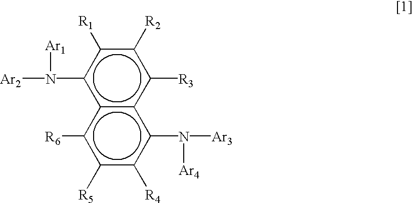
wherein Ar₁ to Ar₄ each independently represents a substituted or unsubstituted C₆₋₂₀ aryl group, with the proviso that at least one of said groups is a styryl group represented by the below-described formula [2], and optionally each of the combinations of Ar₁ and Ar₂, and Ar₃ and Ar₄ may form a ring; and R₁ to R₆ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that either one of R₁ and R₄ does not represent a hydrogen atom; 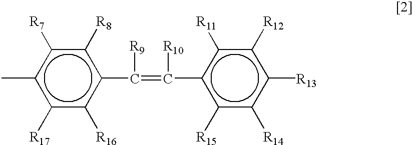
wherein R₇ to R₁₇ each independently represents a hydrogen atom, a halogen atom, a hydroxy group, a substituted or unsubstituted amino group (with the proviso that a diphenylamino group is excluded), a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

2. An organic electroluminescent device comprising an anode, a cathode and at least one emitter layer disposed between them, said emitter layer comprising, singly or as a mixture, a material represented by the following formula [3]: 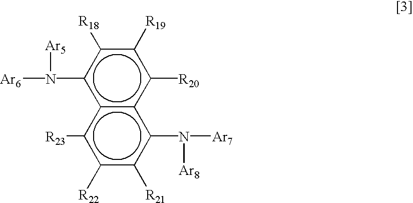
wherein Ar₅ to Ar₈ each independently represents a substituted or unsubstituted C₆₋₂₀ aryl group, with the proviso that at least one of said groups is a styryl group represented by the below-described formula [4], and optionally each of the combinations Ar₅ and Ar₆, and Ar₇ and Ar₈ may form a ring; and R₁₈ to R₂₃ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₁₈ and R₂₁ does not represent a hydrogen atom; 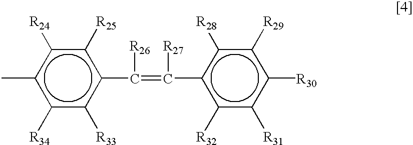
wherein R₂₄ to R₃₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₂₈ to R₃₂ represents a diphenylamino group represented by the following formula [5]: 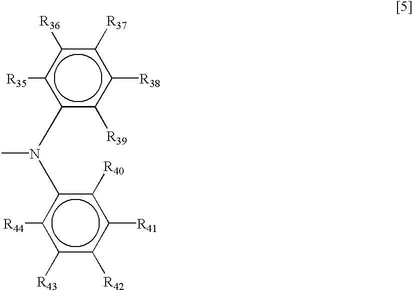
wherein R₃₅ to R₄₄ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

3. An organic electroluminescent device comprising an anode, a cathode and at least one emitter layer disposed between them, said emitter layer comprising, singly or as a mixture, a material represented by the following formula [6]: 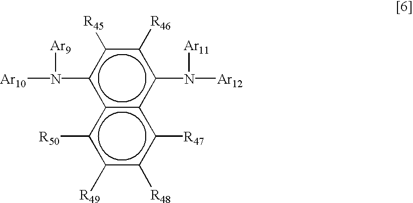
wherein Ar₉ to Ar₁₂ each independently represents a substituted or unsubstituted C₆₋₂₀ aryl group, with the proviso that at least one of said groups is a styryl group represented by the below-described formula [2], and optionally each of the combinations of Ar₉ and Ar₁₀, and Ar₁₁ and Ar₁₂ may form a ring; and R₄₅ to R₅₀ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that either one of R₄₅ and R₄₆ does not represent a hydrogen atom; 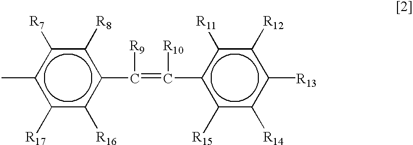
wherein R₇ to R₁₇ each independently represents a hydrogen atom, a halogen atom, a hydroxy group, a substituted or unsubstituted amino group (with the proviso that a diphenylamino group is excluded), a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

4. An organic electroluminescent device comprising an anode, a cathode and at least one emitter layer disposed between them, said emitter layer containing, singly or as a mixture, a material represented by the following formula [7]: 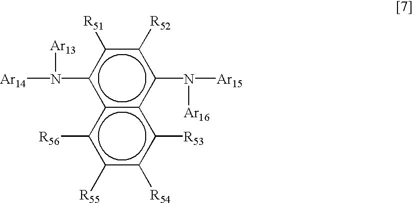
wherein Ar₁₃ to Ar₁₆ each independently represents a substituted or unsubstituted C₆₋₂₀ aryl group, with the proviso that at least one of said groups is a styryl group represented by the below-described formula [4], and optionally each of the combinations of Ar₁₃ and Ar₁₄, and Ar₁₅ and Ar₁₆ may form a ring; and R₅₁ to R₅₆ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₅₁ and R₅₂ does not represent a hydrogen atom; 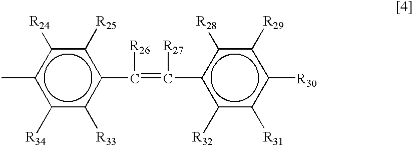
wherein R₂₄ to R₃₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₂₈ to R₃₂ represents a diphenylamino group represented by the following formula [5]: 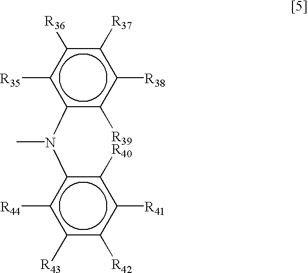
wherein R₃₅ to R₄₄ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

5. An organic electroluminescent device comprising an anode, a cathode and at least one emitter layer disposed between them, said emitter layer comprising, singly or as a mixture, a material represented by the following formula [8]: 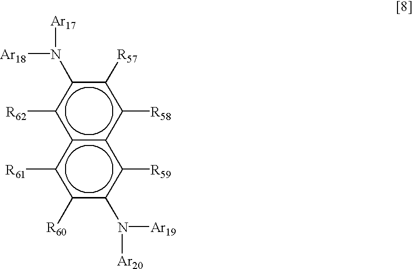
wherein Ar₁₇ to Ar₂₀ each independently represents a substituted or unsubstituted C₆₋₂₀ aryl group, with the proviso that at least one of said groups is a styryl group represented by the below-described formula [2], and optionally each of the combinations of Ar₁₇ and Ar₁₈, and Ar₁₉ and Ar₂₀ may form a ring; and R₅₇ to R₆₂ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one but not all of R₅₇, R₅₉, R₆₀ and R₆₂ represents a group other than a hydrogen atom; 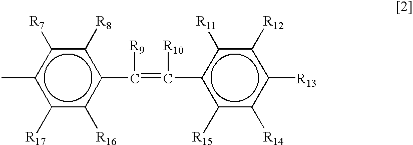
wherein R₇ to R₁₇ each independently represents a hydrogen atom, a halogen atom, a hydroxy group, a substituted or unsubstituted amino group (with the proviso that a diphenylamino group is excluded), a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.

6. An organic electroluminescent device comprising an anode, a cathode and at least one emitter layer disposed between them, said emitter layer comprising, singly or as a mixture, a material represented by the following formula [9]: 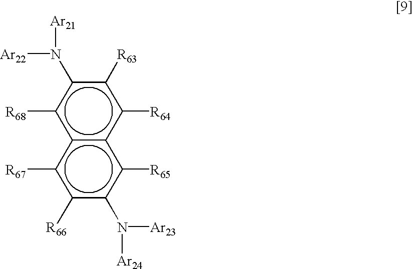
wherein Ar₂₁ to Ar₂₄ each independently represents a substituted or unsubstituted C₆₋₂₀ aryl group, with the proviso that at least one of said groups is a styryl group represented by the below-described formula [4], and optionally each of the combinations of Ar₂₁ and Ar₂₂, and Ar₂₃ and Ar₂₄ may form a ring; and R₆₃ to R₆₈ each independently represents a hydrogen atom, a halogen atom, a hydroxyl group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of R₆₃, R₆₅, R₆₆ and R₆₈ does not represent a hydrogen atom; 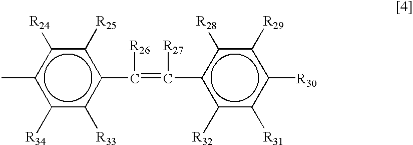
wherein R₂₄ to R₃₄ each independently represents a hydrogen atom, a halogen atom, a hydroxy group, a substituted or unsubstituted amino group, a cyano group, a nitro croup, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group, with the proviso that at least one of said R₂₈ to R₃₂ represents a diphenylamino group represented by the following formula [5]: 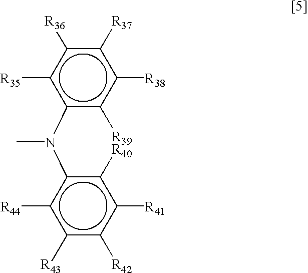
wherein R₃₅ to R₄₄ each independently represents a hydrogen atom, a halogen atom, a hydroxy group, a substituted or unsubstituted amino group, a cyano group, a nitro group, a substituted or unsubstituted alkyl group, a substituted or unsubstituted alkenyl group, a substituted or unsubstituted cycloalkyl group, a substituted or unsubstituted alkoxy group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group or a carboxyl group.
